(19) United States
(12) Patent Application Publication
(10) Pub. No.: US 2004/0249647 A1
(43) Pub. Date: Dec. 9, 2004

(54) Performance measurement and feedback method and system

(76) Inventor: Abel E. Ekpunobi, Chapel Hill, NC (US)

Correspondence Address: JINAN GLASGOW, 300 N. GREENE ST., SUITE 1600, P.O. BOX 2974, GREENSBORO, NC, 27401, US

(21) Appl. No.: 10/456,080

(22) Filed: Jun. 6, 2003

(51) Int. Cl. G06F 17/60

(52) U.S. Cl. 705/1; 705/30

(57) ABSTRACT

A system and method for providing performance measurement and for providing feedback for at least one program, in particular human services organizations, having a multiplicity of respective program participants, wherein the system user(s) include program entities responsible for the program design and implementation and funding entities for providing financial support to the programs, and wherein the system and method provide for Internet-based access by the users thereby providing demonstratable results of the programs in real-time to the funding entities and/or to at least one program entity and ensuring quantifiable, measurable accountability standards for the program entities

### BACKGROUND OF THE INVENTION

(1) Field of the Invention

The present invention relates generally to automated systems and methods for measuring performance of services and providing feedback, and, more particularly, to automated systems and methods for measuring performance of human services programs having participants therein.

(2) Description of the Prior Art

Typically, non-profit services programs are provided to program participants in a variety of applications, with the services programs being funded by other entities and/or individuals as a basis for providing the services. Public and private organizations spend considerable amounts of money and resources toward enhancing the lives of individuals and communities based upon services programs provided thereto. Generally, the funding entities and/or individuals expect that their financial support and contributions to the services programs achieve certain predetermined goals or realize certain results. Also typically, these services programs are managed and operated by individuals having social sciences backgrounds. Traditionally, the predetermined goals or results of the programs have been established in qualifiable terms based upon feedback from program participants, either directly or through reporting or tracking by the agency or entity providing the program services. In some cases, limited quantifiable performance measurements may also have been used. In any case, these results or performance measurements of the services programs based upon the outcomes of the program participants were provided after the completion of the program, and generally after a period of time during which analysis of the results was performed. Unfortunately, in this manner, the programs would have completed at least one course of participant services administration before any feedback on the likelihood of success of the services as measured by the results/goals was provided. As such, the time delay does not provide for corrective action or modification of the program in time to benefit the participants. Thus, the funding entities have no means of tracking or obtaining real-time results of their contributions to the programs providing these services and ultimately to realize any impact on the intended participant group in society. Therefore, the returns on investment by the funding entities and/or individuals are not generally clear, measureable, or even measured by the program-providing organizations.

By way of example, audits of youth programs may show that the expected changes in the program participants did not occur as per the objective of the program and that few grant funds were spent on direct participant-related costs. Also, the level of services provided to the participants were inadequate to effect the predetermined expected changes. Finally, the grantees' reporting of outcomes were unauditable and of limited value in evaluating program outcomes and making appropriate modifications in order to benefit current participants.

Thus, there remains a need for a system and method having real-time data analysis and feedback to a program providing services to participants in order to effect change on a real-time basis to the program participants and to inform the funding entities of the effectiveness of their financial support and contributions to the programs.

### SUMMARY OF THE INVENTION

The present invention is directed to a system and method for measuring performance of human services programs having participants, the programs having predetermined intended outcomes, goals, and/or results for the participants that are measureable, auditable, and reportable on a real-time basis.

Accordingly, one aspect of the present invention is to provide a system for providing performance measurement and providing feedback for at least one program, in particular human organizations, having a multiplicity of respective program participants, wherein the system user(s) include program entities responsible for the program design and implementation and funding entities for providing financial support to the programs, and wherein the system and method provide for Internet-based access by the users thereby providing demonstratable results of the programs in real-time to the funding entities and to the program entities, and ensuring quantifiable, measurable accountability standards for the program entities.

Another aspect of the present invention is to provide a method for operating a system as set forth hereinabove.

Still another aspect of the present invention is to provide a system and method for providing real-time data for services programs having a multiplicity of participants, and analysis thereof, including measurable, auditable and reportable outcomes, goals, and/or results for the participants and/or the program on a real-time basis.

Preferably, these aspects are provided by such systems and methods including web-based data entry and feedback to users of the system, with the data being stored on a database of a server computer accessible via the Internet for providing a comprehensive and objective analysis tool, dynamic constructive modeling, inter- and intra-program comparative analysis for the system users.

These and other aspects of the present invention will become apparent to those skilled in the art after a reading of the following description of the preferred embodiment when considered with the drawings.

### BRIEF DESCRIPTION OF THE DRAWINGS

FIG. 1 is a flowchart of a method for a system constructed according to the present invention.

FIG. 2 is a schematic view of an embodiment of the system of the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

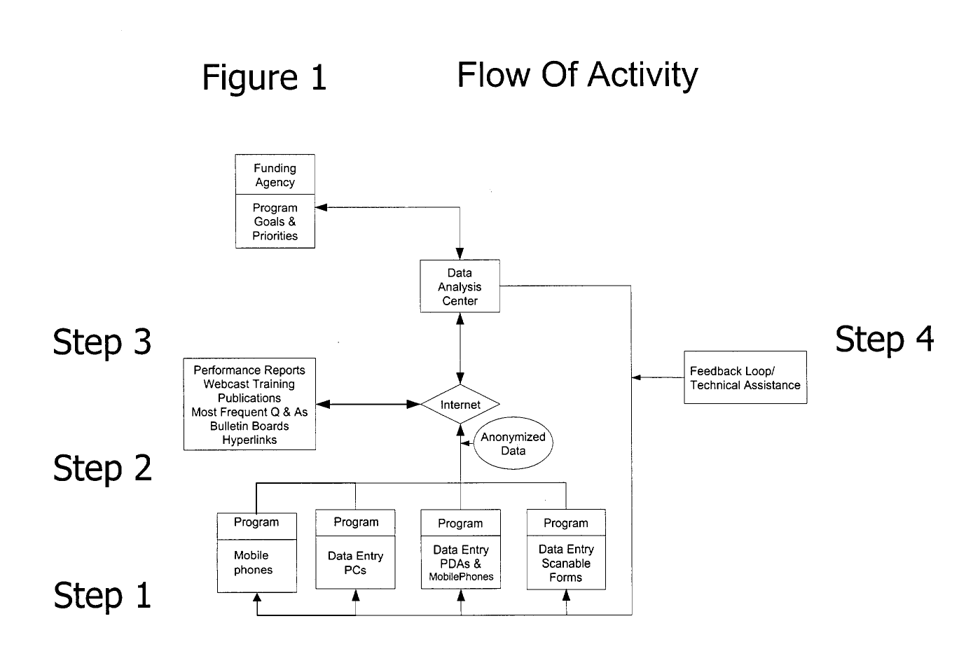

Referring now to the drawings in general, the illustrations are for the purpose of describing a preferred embodiment of the invention and are not intended to limit the invention thereto. As best seen in FIG. 1, a flowchart of a method for a system according to the present invention is shown. Generally referenced 10, the system and method of the present invention are shown with at least four main steps: Step 1 includes providing program data into the system; Step 2 includes anonymizing the data; Step 3 includes analyzing the data; and Step 4 includes providing output in the form of feedback and/or technical assistance for the program and results for the funding agency or entities and for the program entities. These steps may further include data entry and transmission via a network, preferably by the Internet as user(s) enter data through a user interface on a computer screen of at least one remote computer, and/or electronic data and data entry and retrieval devices, including but not limited to personal data assistant devices (PDAs), mobile phones, and the like, the data entry being made via the at least one remote electronic data entry and retrieval devices, including but not limited to computers, personal data assistant devices (PDAs), mobile phones, and the like, the devices connected by the network to a server computer including a database for collecting, storing, anonymizing, and analyzing the data, and for providing feedback and/or technical assistance to the user(s), in particular to the program users, and for providing results output to at least one funding entity that is sponsoring or contributing financially to support the services program and/or to at least one program entity.

Such a system and method according to the present invention are further designed, configured and constructed for providing performance measurement and providing feedback for at least one program providing services to participants, the programs being provided in particular by human services organizations, and the programs having a multiplicity of respective program participants, wherein the system user(s) include program entities responsible for the program design and implementation and funding entities for providing financial support to the programs, and wherein the system and method provide for Internet-based access by the users thereby providing demonstratable results of the programs in real-time to the funding entities and/or to at least one program entity, and ensuring quantifiable, measurable accountability standards for the program entities.

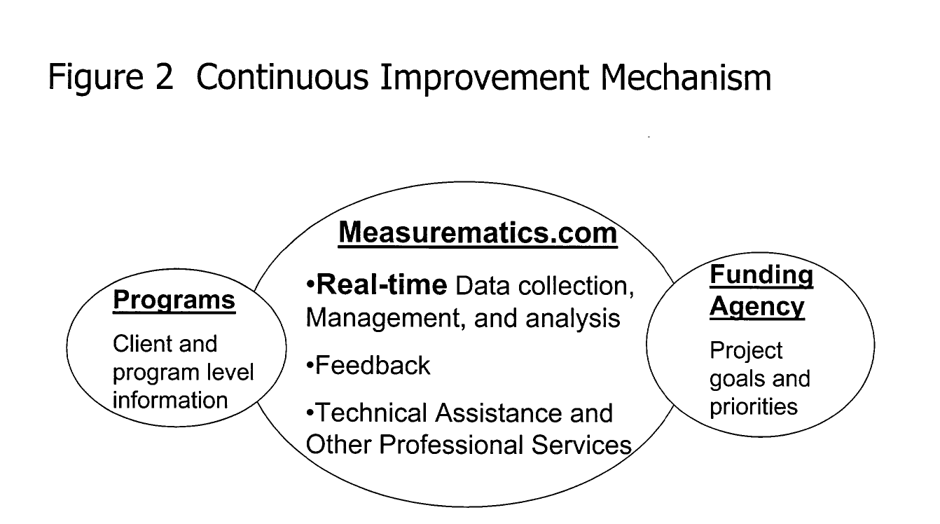

FIG. 2 shows a schematic of the system according to the present invention, in particular depicting the relationship of the at least one funding agency, entity, or individual having predetermined project or program goals, priorities and results or outcomes, and the programs themselves. These funding entities and program entities are interconnected via the system providing and managing the real-time data collection, analysis and feedback, as well as other professional services benefiting one or both of the types of entities.

Furthermore, the system according to the present invention includes software running on at least the server computer and/or the remote computers or electronic data entry/retrieval devices for facilitating the methods as set forth herein. The system includes client information or data, further including demographics, at least one performance measurement, at least one feedback information, program-related data, participant-related data, funding entity-related data, and outcome reports/reporting generated by the system for the users thereof. Preferably, the at least one performance measurement includes at least one measurement that is both quantifiable and measureable, and may also or alternatively include at least one performance measurement that is qualitative and measureable. Also, according to the present invention, at least one program is included in the system, although preferably the system may include and manage a multiplicity of programs that may be related and/or unrelated as to program details, participants, program services providers, funding entities, and outcomes. The program details include the program duration, the frequency of participant attendance and/or participation/activity by the participant in or associated with the program, fidelity and/or compliance with the program requirements, the program entity or program services provider, at least one funding entity per program, program participant(s), progress measurements, the number of participants for a given program, the services received by the participants from the program, and the program or participant outcomes, which may include but are not limited to changes in life and/or behavior patterns indicative of impact of program on participant(s) and/or patterns observable and/or measureable over time.

Preferably, the program performance measurement(s) and feedback are customizable to a given program based upon the specific program details, in particular the expectations and outcomes required by the funding entities or individuals. Also preferably, the program performance measurement(s) are retrofittable to a program already in progress. These may include progress tracking, in particular on a real-time basis based upon the data input by the system users relating to the program and its respective participants. As such, it is preferred that the system is database-enabled, and in one embodiment may include platforms programmed in software code broadly available within the public domain.

One of ordinary skill in the art will appreciate that the system includes a data processing system including a network, preferably one that is website-based on the Internet, but possibly alternatively a local area network (LAN) or wide area network (WAN), the system also including at least one data entry/retrieval device connectable or connected via the network to a server computer having a database. Preferably, the database is developed over time or prepopulated with data relevant to the at least one services program. These data are based upon user inputs and are used to form comparison groups and/or mirror populations and combinations thereof that are used by the system to analyze the data for providing real-time feedback to the services providers and funding entities.

A method according to the present invention includes the main steps indicated in the foregoing as well as the steps of providing a system having the components, configuration and properties as set forth hereinabove; permitting at least one predetermined and authorized user to login to the system on a corresponding at least one remote data entry/retrieval device, such as a computer; the at least one user entering data/information; the at least one user receiving feedback for at least one program based upon the data entered, preferably in substantially real-time such that the information and feedback applicable immediately. Additionally, the present invention provides for an audit method of at least one program and its corresponding outcomes or goals as set forth by the funding entities and/or individuals including the steps of collecting information from a predetermined population in the world wide web-enabled manner set forth hereinabove; the user(s) entering data into the server via website with user login and security; the system performing an automated real-time analysis for providing substantially instantaneous analysis and feedback based upon database comparisons to similar programs and demographics website-based interaction and feedback from the system to the user; determining where program improvements are possible; and modeling constructive solutions for the program; as well as providing reporting to the program and to the funding entities.

Certain modifications and improvements will occur to those skilled in the art upon a reading of the foregoing description. All modifications and improvements have been deleted herein for the sake of conciseness and readability but are properly within the scope of the following claims.

I claim:

1. A system for providing performance measurements and providing feedback for a services program, comprising:
a data processing system having a server computer having a database and at least one remote at least one data entry/retrieval device connectable thereto via a network, with software running on the at least one data entry/retrieval devices for performing predetermined tasks in an automated manner;
at least one services program having a multiplicity of respective program participants, wherein system user(s) include program entities responsible for the services program and funding entities for providing financial support to the programs;
the at least one services program having at least one performance measurement relating to performance outcomes;
data entered by the system user(s) into the database, the data corresponding to the services program and its respective participants;
wherein the data is analyzed and results are output by the server computer to the respective user(s) on corresponding remote at least one data entry/retrieval devices,
thereby providing demonstratable results of the programs in real-time to the funding entities and/or to at least one program entity and ensuring quantifiable, measurable accountability standards for the program entities.

2. The system according to claim 1, wherein the data includes participant information, services program information, and combinations thereof.

3. The system according to claim 1, wherein the at least one performance measurement is quantifiable.

4. The system according to claim 1, wherein the at least one performance measurement is qualifiable.

5. The system according to claim 1, wherein the program is defined by program details, including program duration, frequency of participant participation in the program, fidelity and/or compliance with the program requirements, and combinations thereof.

6. The system according to claim 1, further including program participant progress measurements, including a number of participants, services received by the participants from the program, participant outcomes, and combinations thereof.

7. The system according to claim 1, wherein the program performance measurements are customizable to each program.

8. The system according to claim 1, wherein the program performance measurements are retrofittable to a program already in progress.

9. The system according to claim 1, wherein the database platform is a NET platform.

10. The system according to claim 1, wherein the database has a content that is developed over time.

11. The system according to claim 1, wherein the database has a content that is prepopulated.

12. The system according to claim 1, wherein the data is analyzed based upon comparison groups within the database for programs having similar program details and/or participants.

13. A method for providing performance measurements and providing feedback for a services program, comprising the steps of:
providing a system including a data processing system having a server computer having a database and at least one remote at least one data entry/retrieval device connectable thereto via a network, with software running on the at least one data entry/retrieval devices for performing predetermined tasks in an automated manner; at least one services program having a multiplicity of respective program participants, wherein system user(s) include program entities responsible for the services program and funding entities for providing financial support to the programs;
the at least one services program having at least one performance measurement relating to performance outcomes; data entered by the system user(s) into the database, the data corresponding to the services program and its respective participants; wherein the data is analyzed and results are output by the server computer to the respective user(s) on corresponding remote at least one data entry/retrieval device s;
the user(s) logging onto the network via corresponding server computer(s);
the user(s) entering program-related data into the database;
the database providing analysis and feedback to the user(s) based upon the data entered wherein the information and feedback applicable directly to the corresponding program;
thereby providing demonstrable results of the programs in real-time to the funding entities and/or to at least one program entity and ensuring quantifiable, measurable accountability standards for the program entities.

14. The method according to claim 13, further including the step of providing an audit of the program based upon comparative data for similar programs in the database.

15. The method according to claim 14, further including the step of providing an audit of the program based upon the data entered by the user(s) for a particular program format over time.

16. The method according to claim 13, wherein the system is capable of performing real-time analysis of the data entered.

17. The method according to claim 13, further including the step of determining program improvements.

18. The method according to claim 13, further including the step of modeling constructive solutions for the program.

19. A method for providing performance measurements and providing feedback for a services program, comprising the steps of:
providing program data into a system according to claim 1;
anonymizing the data;
analyzing the data; and
providing output in the form of feedback and/or technical assistance for the program and results for the funding agency and/or to at least one program entity.
